(19) United States
(12) Patent Application Publication
(10) Pub. No.: US 2017/0329919 A1
(43) Pub. Date: Nov. 16, 2017

(54) PERSONALIZED USER INTERFACES PRESENTING CARE TASKS

(71) Applicant: Sphere3, LLC, Kansas City, KS (US)

(72) Inventors: Kourtney Govro, Raymore, MO (US); Devon Kerns, Savannah, MO (US); Steven Kent Mills, Overland Park, KS (US); Kyle Evans, Faucett, MO (US); Rodney Corn, Anthem, AZ (US); Tanner Cook, Prairie Village, KS (US); Kristal Rayson, Independence, MO (US)

(21) Appl. No.: 15/591,523

(22) Filed: May 10, 2017

Related U.S. Application Data
(60) Provisional application No. 62/333,955, filed on May 10, 2016.

(51) Int. Cl. G06F 19/00; G06Q 10/06

(52) U.S. Cl. CPC G06F 19/3406; G06F 19/327; G06Q 10/06311

(57) ABSTRACT

Media, method, and system are described for generating a graphical user interface presenting care tasks to a care provider. Particularly, embodiments describe sensing a location such as a department, floor, or clinic, retrieving a population of patients, and producing a graphical user interface of care tasks to be performed. In embodiments, the graphical user interface may be generated based on prior performance of the care provider.

### RELATED APPLICATIONS

This non-provisional patent application claims priority benefit, with regard to all common subject matter, of earlier-filed U.S. Provisional Patent Application No. 62/333,955, filed May 10, 2016, and entitled CARE LOGGING UTILITY WITH PERSONALIZED METRICS. The identified earlier-filed provisional patent application is hereby incorporated by reference in its entirety into the present application.

This non-provisional patent application discloses subject matter that integrates with subject matter disclosed in U.S. patent application Ser. No. 13/795,501, filed Mar. 12, 2013, and entitled SYSTEMS AND MODULES FOR IMPROVING PATIENT SATISFACTION; and disclosed in U.S. patent application Ser. No. 15/585,421, filed May 3, 2017, and entitled GRAPHICAL USER INTERFACES RECOMMENDING CARE. The identified earlier-filed patent applications are hereby incorporated by reference in their entirety into the present application.

### BACKGROUND

### 1. Field

Embodiments of the invention are broadly directed to methods and systems of generating graphical user interfaces presenting care tasks to be performed by care providers, such as nurses, physicians, or unlicensed assistive personnel. Specifically, embodiments of the invention collect a set of care tasks to be performed, generate a graphical user interface presenting the care tasks reflecting a personalized care metric of a care provider, and present them to the care provider.

### 2. Related Art

Many employers of healthcare providers, such as hospitals and long-term nursing facilities, critique the level of care being provided based on personalized care metrics such as a Patient Request Rate, Patient Interaction Wait Time, Critical Request Rate, or Interruption Rate. Improvement of these metrics is desirable for a care provider, both in order to administer the highest quality care to patients and to achieve the greatest satisfaction of their employer.

Traditionally, systems present care tasks to care providers based solely on the immediate needs of patients, without consideration of the advanced personalized care metrics. Inclusion of the metrics may benefit patients long-term and maintain an awareness to the care provider of the values that will ultimately be the measuring stick by which the provider's work is judged. Further, care providers, especially those that are responsible for many patients at one time, can often become overwhelmed with balancing and prioritizing the various needs of each of their patients when presented with a raw list of tasks to be performed, without additional information and/or formatting to guide their provision of care. Accordingly, there is a need for improved systems and methodologies to generate graphical user interfaces configured to generating graphical user interfaces presenting care tasks that denote one or more personalized care metrics to providers of care.

### SUMMARY

Embodiments of the invention address these needs by generating graphical user interfaces at locations of care that present patient tasks to a care provider based on previously documented patient experience data. Embodiments of the invention may further include steps of generating the list of tasks based on a plurality of experience and/or care records, prioritizing these tasks based on patient experience data, and presenting them to a provider in a format or style indicating urgency, order, and/or motivation. Embodiments of the invention include various systems and methods for generating, correlating, and presenting graphical user interfaces using patient experience and care data that may be specific to an identity of one or more care provider and/or a care location.

In a first embodiment, a method of managing patient experience data generates a graphical user interface configured to display a set of care tasks for a population of patients at a location of care. The set of care tasks includes are compiled, at least in part, based on the location of care. Particularly, the set of care tasks may be presented in a manner reflecting a personalized care metric of a set of providers of care that receive the interface. Each care task may be presented on the graphical user interface with a time for completion and/or care provider responsible for completion.

In a second embodiment, a method of managing patient experience data begins with begins with the steps of establishing the identity of a care provider and sensing a location of care. Next, a set of care tasks are compiled for a generated population of patients at the location of care. A graphical user interface presenting the set of care tasks may then be produced based, at least in part, on the personalized care metric. Thereafter, the set of care tasks to be performed and/or personalized care metric of the care provider may be updated, and an appropriately adjusted graphical user interface may be produced.

In a third embodiment, a system for managing patient experience data includes a computer terminal including a processor, an identity input component, a location sensing component, and a non-transitory computer readable medium. The computer readable medium stores computer-executable instructions directing the processor to perform the steps of establishing an identity of a care provider via the identity input component and sensing a location of care via the location sensing component. A population of patients at the sensed location of care is generated, and a personalized care metric of the care provider determined. Thereafter, the instructions direct the processor to produce a list of tasks for the population and prioritize those tasks based at least in part on the experience records. Finally, the system generates a graphical user interface presenting the set of care tasks based, at least in part, on the personalized care metric.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform for certain embodiments of the invention;

FIGS. 2A-D depict examples of graphical user interfaces that may be presented on a display in embodiments of the invention;

FIG. 3 depicts multiple care locations at which one or more patients may receive care;

FIG. 4 depicts a patient room including an electronic beacon and a location indicium;

FIG. 5 depicts a first flowchart illustrating the operation of a method in accordance with an embodiment of the invention; and

FIG. 6 depicts a second flowchart illustrating the operation of a method in accordance with an embodiment of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

Embodiments of the invention are directed to systems and methods for generating a graphical user interface based, at least in part, on personalized care metrics measuring care provided by one or more care providers for whom the graphical user interface is being generated. Embodiments may collect a set of care tasks to be performed for a population of patients at a location of care that may be automatically sensed. Embodiments of the invention may further produce graphical user interfaces presenting these care tasks as prioritized lists and/or heat maps. These examples are not intended as limiting. Embodiments of the invention may be applied in any situation in which one or more care providers have a set of care tasks to perform for one or more patients.

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art, and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments, but is not necessarily included. Thus, the technology can include a variety of combinations and/or integrations of the embodiments described herein.

### Operational Environment for Embodiments of the Invention

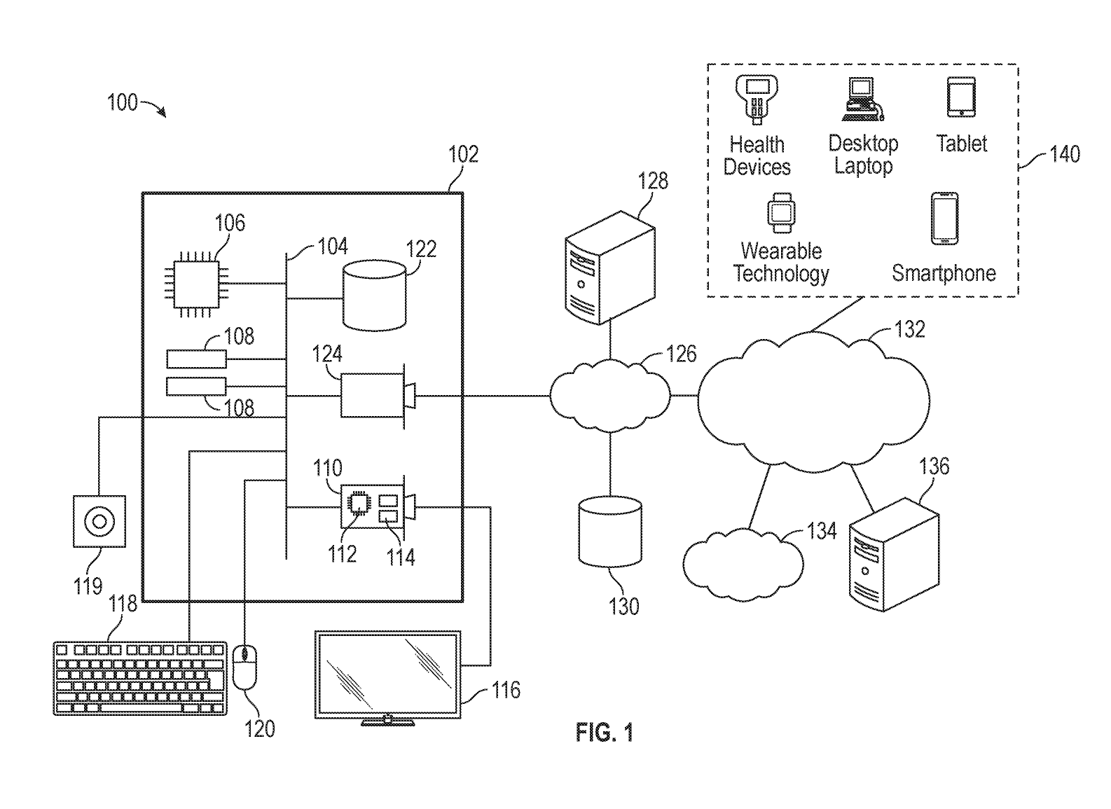

Turning first to FIG. 1, an exemplary hardware platform that can form one element of certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules. Also attached to system bus 104 is graphics card 110. In some embodiments, graphics card 104 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102.

Similarly, peripherals such as keyboard 118, indicium receiver 119, and mouse 120, a location sensing component, and an identity sensing component are connected to system bus 104. A location sensing component may include a Global Positioning System (GPS) processor or any equivalent system of automatic geographical location sensing. Additionally, a location sensing component may utilize an internal real time location indication platform including RF, IR, and/or WiFi-based location indicators. An identity sensing component may comprise a biometric scanner such as a fingerprint scanner. Like display 116, these peripherals may be integrated into computer 102 or absent. In some embodiments, indicium receiver 119 may be a digital camera, barcode reader, or hardware supporting short-range wireless communication such as RFID, Bluetooth, or infrared (IR) beam communication. Also connected to system bus 104 is local storage 122, which may be any form of computer-readable media, and may be internally installed in computer 102 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-usable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as server 130. In some embodiments, NIC 124 may serve as part or all of a location sensing component, as further described below.

Generally, a data store such as server 130 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Server 130 should not be strictly viewed as a single server at a singly physical location, but rather may be comprised of a plurality of data storage servers that may be located at multiple, remote locations.

Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132. Through connection 132, the system may be communicatively coupled to devices, wearables, appliances, facility structures, and other electronic experience documentation devices, represented in FIG. 1 by element 140.

Embodiments of the invention may utilize data relating to patient health, behavior, and satisfaction collected in a wide variety of ways. Some data may be manually entered via the patient or care provider via a workstation, an internet web portal, kiosk, application running on a wireless device, or by any other manual method. Additionally, data may be pulled automatically from previous electronic medical records or from scanned-in paper records with optical character recognition (OCR). Behavioral or experience data may additionally be recorded directly from a communicatively coupled device, sensor, monitor, or other technologies used by a patient to communicate a need or activity either physically (i.e. via push of button, movement, or other user input) or physiologically (i.e. from a cardiac or other monitor).

Location and movement data stored in a patient's record may be extracted from sensors, monitors, and/or other various readers included in a data table. Data may be fed to the system from databases of outside sources such as labs and imaging centers. Further, health and/or behavior data can be collected from wearables, such as a pedometer, activity tracker, blood pressure cuff, or diabetic monitor. Such “wearables” may be in the form of an application running on an electronic device worn or carried by the patient, such as a dedicated activity tracker, such as a distance-tracking smart watch, or a mobile device, such as a smartphone.

In embodiments, data from wearables may be periodically collected from a web-based cloud, such as server 130. Further yet, data may be transmitted to the system from larger appliances such as infusion pumps, ventilators, treadmills, or electronic scales. Embodiments of the invention may be communicatively coupled with and draw data from facility-wide structures, such as nurse call systems, interactive patient beds, and real-time location systems. The above data sources are intended only to be exemplary and are in no way meant to limit the invention. Data acquired by any means from any source may be used in the embodiments of the invention.

Data acquired through wearables, sensors, and monitors may be used to analyze providers' engagement and workload with one or more patients during a shift and/or across many shifts. Similar to how the behaviors of patients are measured through their movements, needs, and requests (both physical and physiological), the movements and engagements of a provider (e.g. nurse, doctor, therapist) may be used in embodiments of the invention to manage the provider's true workload as opposed to the perceived workload indicated in a medical record.

Traditionally, a provider's time is often managed by calculating an allotted amount of time to manage a patient's care using the acuity level, diagnoses, and/or symptoms and of a patient. Time allocated in this standard acuity model often does not take into account “non-scheduled” activities such as interruptions, walking distance, loss of equipment, and other indirect consumers of a care provider's time. Embodiments of the invention may account for these “non-scheduled” activities in addition to performing steps of the traditional time management model.

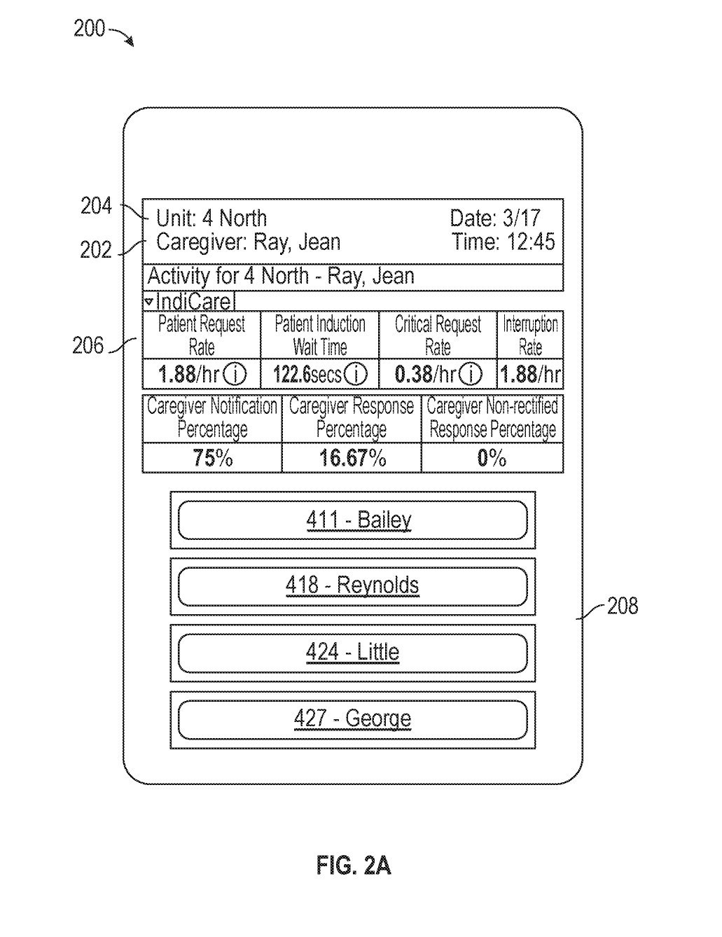

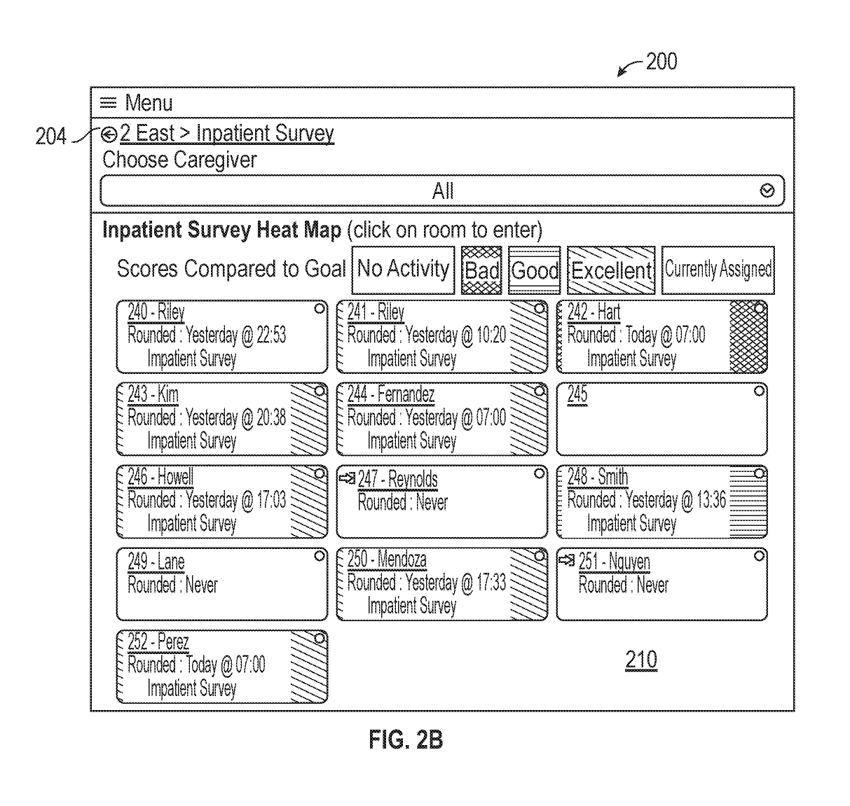

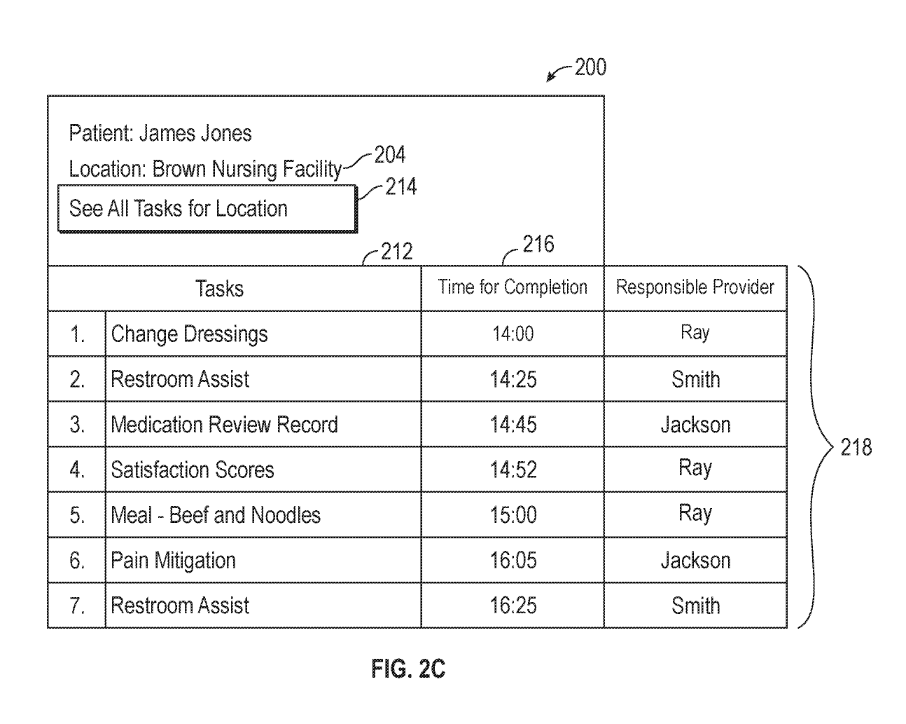

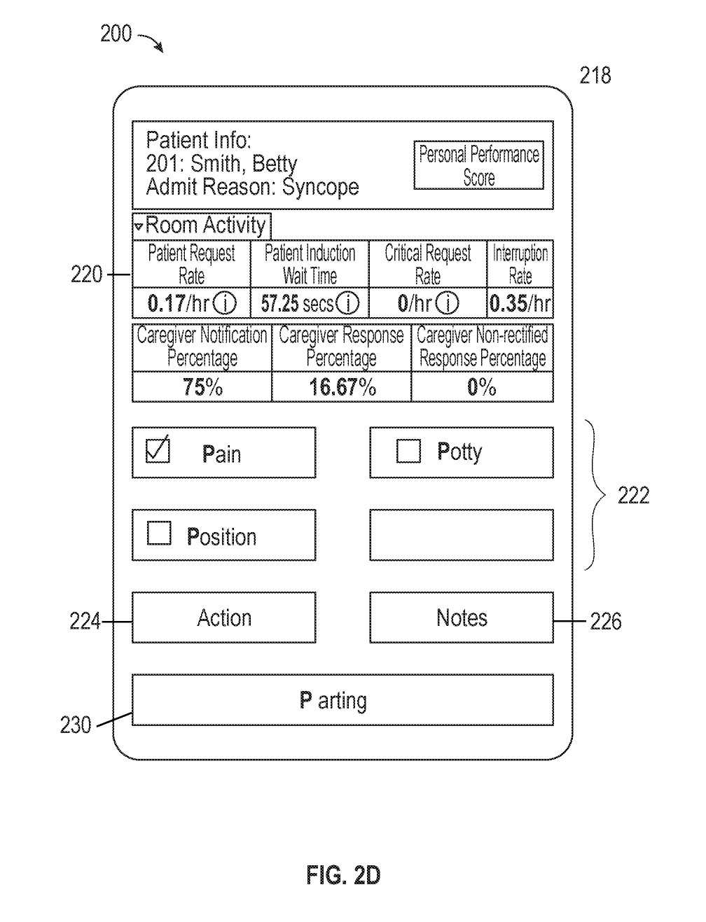

Embodiments of the invention include systems and methods of generating graphical user interfaces presenting care tasks to be performed based at least in part on personalized care metrics, as illustrated in the examples of FIGS. 2A-D. Examples of personalized care metrics include Patient Request Rate, indicating how often the patient is needing care, Patient Interaction Wait Time, indicating how long (on average) the patient is having to wait for care, Critical Request Rate, indicating how often the patient is expressing an emergent need for care, and Interruption Rate, indicating how often the patient and subsequent “escalations” are disrupting or creating variability in the workload of a care team. These examples are not intended to be limiting. Other personalized care metrics, such as a Caregiver Response Percentage or any other advanced analysis of care provided may be employed in alternative embodiments of the invention.

Further, embodiments of the invention may enable the automation of a “round,” and/or facilitate the visualization of personalized care metrics during rounding. A “round” in this disclosure describes a visit with a patient to assess their current health, well-being, state of mind, and satisfaction, completed by one or more associated care providers. This act is typically done on a regular, periodic basis and generally completed by one or more members of a “team” of care providers. Rounds are imperative to understanding a patient's pain, compliance, engagement, and overall response to medications. Embodiments of the invention may measure providers on their ability to manage variable requests from the patient and provide real time visibility into their performance.

FIG. 2A is one example of a user interface that may be generated in embodiments of the invention, displaying a list of patients in need of a round by a care provider 202, Nurse Jean Ray. Illustrated in FIG. 2A is a displayed interface 200 showing reference information including the care provider's name 202 and the current location 204, as well as the date and time. Additionally, displayed interface 200 includes personalized care metrics information 206 analyzing the current and/or prior performance of the care provider 202. Displaying personalized care metrics information 206 allows the care provider 202 to be continuously aware of the level of care being provided.

Patient list 208 included on displayed interface 200 presents a plurality of patients requiring care from care provider 202. In some embodiments, selection of a patient from patient list 208 may display one or more tasks to be performed by care provider 202 for that patient. In embodiments, the patient list 208 may be color coded or otherwise formatted in an attention seeking manner to display urgency of care requested, an impending time for completion of a care task for the patient displayed, and/or a status of a personalized care metric for the given patient.

For example, a patient list icon for a patient that has been waiting an hour for a requested medication may be displayed red and/or flashing to indicate that the task is overdue. Further, the patient name may be displayed in specially formatted text, such as all capitals or bolding, to indicate that this patient is contributing negatively to one or more personalized care metrics for the care provider 202. Additionally or alternatively, the device displaying interface 200 may vibrate and/or generate audible alerts of urgency or criticality of care requested, in embodiments.

FIG. 2B illustrates an alternative displayed interface 200, presenting the patient list 208 as a heat map 210. In embodiments, the heat map 210 may be color-coded, with colors such as orange indicating that a particular patient needs urgent attention to prevent a likely drop in health or satisfaction, or other colors such as blue indicating that a patient may be of lower priority need at the moment. The heat map 210 may additionally display a set of care tasks to be performed by care provider 202 and a time for completion for each care task.

In a further embodiment, illustrated in FIG. 2C, a set of care tasks 212 may be displayed for one or more patients to care provider 202 on displayed interface 200. In some embodiments, the set of care tasks may be presented in a prioritized task list, recommending to the provider which tasks should be completed first to improve one or more personalized care metrics 206. Location 204 displays the location of care at which the patients are being treated, which may be used in embodiments of the invention for generating a population of patients and producing the set of care tasks 212 to be accomplished, as further discussed below. In some embodiments, a care provider 202 may select a button 214 to see a full list of tasks to be accomplished for the population of patients at that location, possibly prioritized by order of completion.

Care task list 212 displays a plurality of tasks that have been produced for one or more and prioritized by order of recommended completion. In some embodiments, the order of completion is determined based on one or more personalized care metrics 206 of one or more care providers 202. In some embodiments, the personalized care metrics 206 on which the prioritization of the care task list 212 is generated may be restricted to care provision by the care provider 202 at the particular location of care 204. Additionally or alternatively, the personalized care metrics 206 on which the prioritization of the care task list 212 is generated may be restricted to care provision by the care provider 202 within a prescribed lookback period, such as care provided in the past week, month, or year.

Further, some embodiments may display an indication that one particular care provider 218 from a set of care providers at the location 204 is responsible for the completion of each given care task on care task list 212. For example, as seen in in column 218 on FIG. 2C, Nurse Ray is responsible for completion of a number of care tasks 212 including changing the patient's dressings, recording satisfaction scores, and providing a meal. Similarly, a pharmacist, Dr. Jackson, is be responsible for performing a medication review and assisting in pain mitigation, while Mr. Smith, a certified nursing assistant (CNA), is responsible for assisting the patient in using the restroom. In embodiments, the responsible care provider 218 listed may not be required to actually perform the care task 212 for which he or she is responsible, but rather only to ensure that it is completed and/or documented. In other embodiments, the responsible care provider 218 listed may be required to actually perform the care task 212.

FIG. 2D displays an exemplary graphical user interface 200 that a care provider 202 such as a nurse might be presented when using an embodiment of the invention to document a rounding visit with a patient. The displayed interface 200 may be selected manually by a care provider, for instance by clicking or selecting a patient's name or room from one of the screens displayed in FIG. 2A or 2B, or may automatically appear on the screen when a real-time location sensing system as described below registers that an electronic device has entered a patient's room. The displayed interface 200 displays identification information for the particular patient 218, room activity metrics 220, task list buttons 222, and further action buttons 224, a note button 226, a satisfaction score 228, and visit completion button 230. Any or all of these elements may or may not be present with any number of other elements. Presence or lack of any particular element is not meant to be limiting to the scope of embodiments of this invention in any way.

Identification information 218 such as the patient's name, room, or admit reason may be displayed at the top of the screen as a reminder to the nurse of the particular patient's details, as well as an error reduction tool. Other data that might appear for these purposes include Medical Record Number (MRN), age, a picture of the patient's face, or a simple physical description. These examples are meant only to be exemplary, and are not intended to limit the invention. This information may be drawn directly from the patient's linked medical record. A patient picture of the patient (not illustrated) may be taken using the application by a provider at any time and displayed as part of the identification information for increased patient/provider rapport and error prevention.

Room activity metrics 220 display valuable statistics to providers to help assess the quality and quantity of care that has been given to a particular patient. Metrics displayed include Patient Request Rate, indicating how often the patient is needing care, Patient Interaction Wait Time, indicating how long, on average, the patient is having to wait for care after requesting it, Critical Request Rate, indicating how often the patient is expressing an emergent need for care, and Interruption Rate, indicating how often the patient and subsequent “escalations” are disrupting or creating variability in the workload of a care team. The Interruption Rate may be augmented by a cardiac monitor, IV Pump and/or other electronic care devices that are related to patient care. Critical request data may further reflect the rate at which others are expressing an emergent need for care on the patient's behalf, such as a need for resuscitative efforts or a report of an unsanctioned bed exit.

Any or all of this data may be supplied on an interface 200 to help provide an overall visualization of a patient's care to a care provider in embodiments of the invention. These parameters are meant only to be exemplary of the types of metrics that could be calculated and displayed by the system to assist providers in managing the amount of care being devoted to each of their patients. In embodiments of the invention, the parameters shown on an interface 200 may be selected by administrators and/or may be chosen from a set of parameters available by particular providers or a set of providers. Similarly, administrators and/or providers may be able to control the timespan over which the activity metrics calculate their values in embodiments. This timespan may be any value or may be selected from a set of allowed values, such as past hour, past 12 hours, past day, and/or entire stay.

In embodiments, a visual timeline is displayed below the room activity metrics, which may show particular events in the patient's care over a set number of hours, and/or may show line graphs of the displayed room activity metrics. Being able to see the trends of the room activity metrics in a visual form allows a care provider to assess the level of care a patient is receiving and how that level of care is changing over time. The visual timeline displayed on an interface 200 may show the same timespan as has been applied to the room activity metrics, and may similarly be configurable by a provider and/or administrator to show a particular length of time or set of parameters, in embodiments.

Activity metrics 220 and the visual timeline may display parameters and trends as an average across an entire unit, location, facility, or a subset of a care provider's patients. The activity metrics and timeline may shift to display only those of a particular patient when the system senses the device running the application has entered a patient's room, the provider scans a patient's or room's barcode, or upon other location sensing triggers, as will be further described below. Similarly, an electronic device running an embodiment of the invention may update or adjust the subsets of patients for which activity metrics and visual timeline are displayed when the device senses it has entered a new unit or facility.

Task list buttons 222 in FIG. 2D each represent a common task nurses complete each time they round on a patient: Pain, Potty, and Position. These task buttons are merely exemplary, and may include more, fewer, or different tasks to be completed on each visit. Similarly, the tasks listed may be those typically performed by other providers, such as doctors or technicians. The tasks listed may change based on the patient, room, unit, time of day, day of the week, provider logged into the application, or any other parameter available to the application. Tasks may be configured in some embodiments at the provider's discretion, while in other embodiments the tasks are set by an administrator and cannot be configured by providers. In alternative embodiments, providers are able to add to tasks list buttons 222, but are unable to remove any.

Task list buttons 222 serve as both a reminder to the providers of tasks that need to be completed and as a convenient link to activities within the application where the tasks can be documented. Clicking on a task may pop-up or otherwise redirect the application to a documentation screen for that task and/or may indicate visually that the task has been completed for this visit. For instance, completion may be shown as in FIG. 2D as the checkmark next to “Pain,” or alternatively could be a color-coding, deactivation, or strikeout of the button. Embodiments may also or alternatively display visually an unsuccessful attempt to complete the activity, for instance by showing a large red X if the patient refuses to visit the bathroom. These examples are meant only to be exemplary, and are in no way limiting on the scope of the invention.

Action buttons 224 allow a care provider to manually or automatically send a message to another care provider, a group of care providers, or team (such as housekeeping, maintenance, religious services, or pharmacy) that a patient has a need to address. Selection of action request button 224 may redirect or pop-up an action screen with particular actions to request. Actions selectable in the system may include any or all of concierge requests for ice, a manager, food tray, minor cleanup, TV repair, and/or a bed change. Further, requests initiated using an action request button 224 could include clinical level requests such as a pain medication consult from the pharmacy. These are merely examples, and are not in any way meant to be limiting on the types of actions the buttons could automatically request. As with the task list buttons 222, the action requests may be configurable by administrators and/or providers.

Note button 226 allows the provider to view and/or write notes for their own use. In addition, these notes may be able to be viewed by all or a subset of other care providers. In some embodiments, the note button may flash, change color, or in any other way draw a care provider's attention when the provider begins documentation and/or enters a patient's room if there are notes to be read. Notes may be entered by typing or using a voice to text function, in embodiments.

Satisfaction score 228 in FIG. 2D may be calculated by the system based on weighted values of current and prior health and experience data. The satisfaction score may be based on functions transforming past health and behavior parameters into satisfaction levels, and the system may update these functions as actual satisfaction data points are collected from the patient. Satisfaction scores may be presented to providers or patients in any form, including a number, color code, or pictograph. Sudden changes in satisfaction score may be used to identify trigger levels of health or behavior parameters, leading to a significant gain or drop in patient satisfaction. Trigger levels may further be partially or wholly based on deviations from average values in a single or across multiple parameters of health and behavior. Some values may intentionally be excluded from a patient's satisfaction score so that a provider is not motivated to skew the parameter, such as pain level, in a direction that would improve the patient's satisfaction score. As with the activity metrics 220, a satisfaction score may be displayed as an average for all patients for a care provider or all patients in a particular unit or facility.

Visit completion button 230, illustrated in FIG. 2D as a “Parting” button, may display a message to the provider to remind the patient of the next scheduled round, procedure, or medication. The message displayed may be configurable by providers and/or administrators to remind the care provider of additional details particular to a patient's care, and/or may display suggestions determined by the system to increase the satisfaction score of the patient. In some embodiments, visit completion button 230 may function to send, store, and/or finalize data for the visit that may have been temporarily stored locally on an electronic device during the visit.

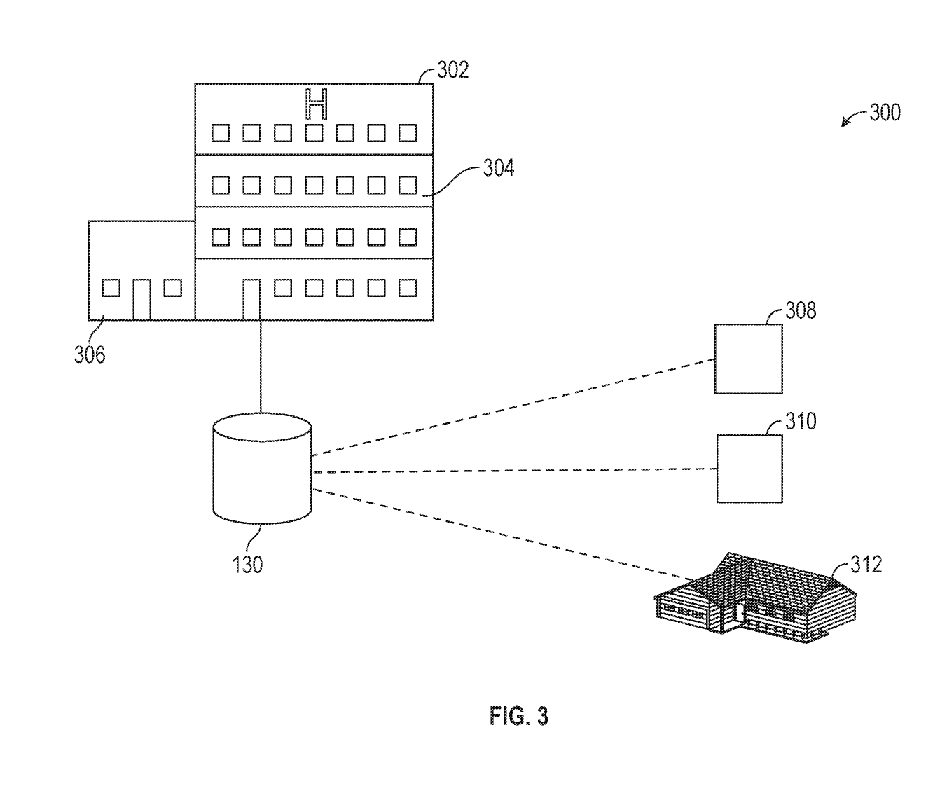

As mentioned above, in embodiments of the invention, processor 106 may compile a set of care tasks to be completed by one or more care providers based on a current location of care. As seen in FIG. 3, a location of care may be a hospital 302, a clinic 310, a long-term nursing facility 312, or a patient home 314. Hospital 302 includes a floor 304, a department 306 such as a Pediatrics Department, and an exemplary patient room 308. In embodiments of the invention, the set of care tasks compiled may be selected based on any of these locations. These locations are not intended to be limiting. Any location at which care is provided to one or more patients may comprise a location of care in embodiments of the invention. Embodiments of the invention may include a location sensing component for determining any or all of the above levels of location of care partially or completely automatically, as further described below.

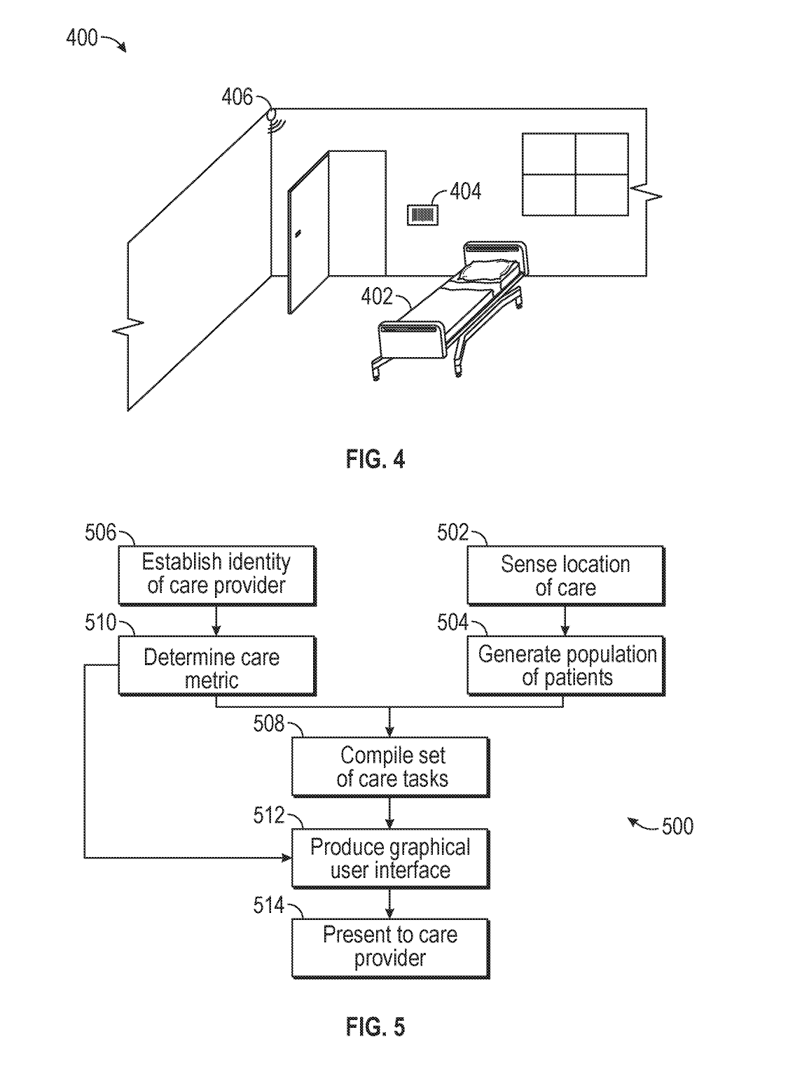

In some embodiments of the invention, a location sensing component of an electronic device configured to display a graphical user interface to a care provider may automatically sense the location of care in which the care provider 202 is practicing. Turning now to FIG. 4, this location sensing may be achieved in embodiments of the invention through an electronic scan of an indicium 404. Indicium 404 may be provided as a one-dimensional or two-dimensional barcode presented on a sign mounted in a patient room 308, a department 306, or a floor 304. Alternatively, indicium 404 may be uniquely associated with an entire clinic 310 or a particular bed 402 at a care location 400 with multiple beds.

For example, a tablet computing device carried by a rounding nurse may be equipped with an infrared barcode scanner. Upon scanning indicium 404, the tablet computing device captures information related to the care location 400, perhaps through consultation of a locally or remotely stored lookup table. The computing device may then use the location of care to compile a set of care tasks to be performed for one or more patients at the location of care sensed for generation of a graphical user interface 200. In embodiments, the indicium 404 indicating a location of care may be captured by a digital camera integrated into an electronic device, such as the tablet computing device or a smart phone.

In alternative embodiments, a location of care may be automatically sensed by an electronic device through establishment of a wireless connection with an electronic beacon 406. In embodiments, electronic beacon 406 may be a wireless internet hub providing a Wi-Fi connection, with location of care sensed by an electronic device based on the signal strength of the Wi-Fi connection. For example, a large hospital 302 my have a wireless internet hub for each floor 304 in the hospital. An electronic device may sense and/or be capable of establishing a Wi-Fi connection with more than one of the internet hub electronic beacons 406. However, the nearest beacon 406, the internet hub for the floor on which the care provider is standing, will provide the strongest signal to the electronic device. In embodiments, the electronic device may determine a location of care based on the strongest wireless internet signal available, and may thereafter generate a population of patients to be cared for at that location of care.

Alternatively, electronic beacon 406 may establish a communication link with an electronic device via Bluetooth ™ or other wireless communication protocol with a limited range, and thereafter transmit to the device an identification of the location of care. These examples are not intended as limiting. Any other method of communicating wirelessly with an electronic beacon 406 to determine a location of care, such as an RFID connection, may be employed in embodiments of the invention. In alternative embodiments, a location of care may be sensed without establishing a connection with electronic beacon 406, such as through use of a Global Positioning System (GPS) or other system for determination geographic proximity. Embodiments may use any of the above methods of location determination alone or in combination and may further require manual user input.

An exemplary method 500 utilizing an automatic determination of a location of care to generate a personalized user interface presenting a set of care tasks to a provider of care is illustrated in FIG. 5. Method 500 begins at step 502, in which a current location of care is sensed, as detailed above. In some embodiments, this may be accomplished using any combination of GPS, a wireless connection, and manual user input. Particularly, a wireless tablet computing device (or any other electronic computing device) may, in an embodiment, determine that a nurse is located on a particular floor based on her confirmation of a Wi-Fi connection to the floor's wireless internet hub.

In step 504, a population of patients is generated based at least in part on the location of care sensed in step 502. This population may be all patients at that location, such as all residents of a long-term nursing facility 312, or may be restricted to only a subset of the patients at the location of care based on one or more additional parameters, such as a role of the care provider for whom a graphical user interface is being generated.

In step 506, an identity of the care provider utilizing the invention is determined. For example, this role may be as general as a Care Team Member, may denote that the care provider is a Nurse, or may specific that the care provider is a doctor who serves as the Primary Care Physician for a set of patients at a location of care. These examples are not intended as limiting. Roles may include a title, occupation, level of seniority, designation (such as “Hospitalist”), indication of temporary employment, or any other distinction that may be drawn to include some providers of care and exclude others. The identity of the care provider may be established using biometrics such as fingerprint, eye, or voice identification, manual or automatic input of a username and/or password, and/or by presentation of an identifying item, such as a badge. In one embodiment, an indicium from a care provider's badge may be scanned to establish identity in the same manner as described above for an indicium indicating a location of care.

At step 508, a list of care tasks is compiled to be performed for the population of patients generated in step 504, which may be performed based, at least in part, on the identity of the care provider established in step 506.

For example, a Physical Therapist using an embodiment of the invention at a long-term nursing facility 312 may only need to see care tasks to be performed for residents of the facility that have recently had surgery, experience a fall episode, and/or have complained of pain or requested a visit. Upon logging into the system, a location sensing component such as a GPS chip may determine that a mobile electronic device of the care provider is at the long-term nursing facility 312 and generate a population of patients in need of a visit from the therapist based on need and request. This is merely one example of an embodiment, and is not intended to be limiting to the device, role, parameters, or location sensing behaviors described.

In an alternative example, a team of nurses operating at the same long-term nursing facility 312 may be presented with a list of tasks to be performed by any of the nurses on-duty at the location of care. In such an embodiment, the role of “nurse” is used to compile care tasks for the population of patients at the facility 312, though the tasks may not be particularly assigned to any individual nurse within the group. In this case, each care provider in the set of care providers for whom a graphical user interface is being generated shares the role of “nurse.”

In step 510, a processor 106 determines a personalized care metric for the identity of care provider established in step 506. This may occur before, during, or after the compilation of care tasks in step 508. In embodiments where care tasks are compiled based on the identity of an individual care provider, the personalized care metric determined in step 510 may be a personalized care metric for that individual provider, such as an Average Patient Interaction time, a Patient Minimum Wait Time, or a number of task Time for Completions missed. These are merely examples, and are not intended as limiting.

In embodiments in which care tasks are compiled in step 508 based on the identity of a set of care providers, such as the role of “nurse” described above, the personalized care metric determined in step 510 may be an averaged personalized care metric for the entire set of care providers. Alternatively, the personalized care metric may be the minimum or maximum of the care metrics for all care providers in the set of care providers. In embodiments, multiple care metrics for one or more care providers is determined in step 510.

In step 512, processor 106 produces a graphical user interface based on the set of care tasks compiled in step 508 and the care metric(s) determined in step 510. As discussed above, the graphical user interface may comprise a set of patients, list of care tasks to be completed, heat map of patients, and/or indication of prioritization or time completion. In some embodiments, the user interface generated may prioritize highest those care tasks that are having the largest negative impact on one or more personalized care metrics.

Finally, the graphical user interface generated in step 512 is presented to one or more care providers in step 514, perhaps via display 116, which may be a display of a mobile electronic device. In embodiments, the graphical user interface generated is presented to at least the care provider whose identity was established in step 506. In some embodiments, the graphical user interface generated is presented to only the care provider whose identity was established in step 506.

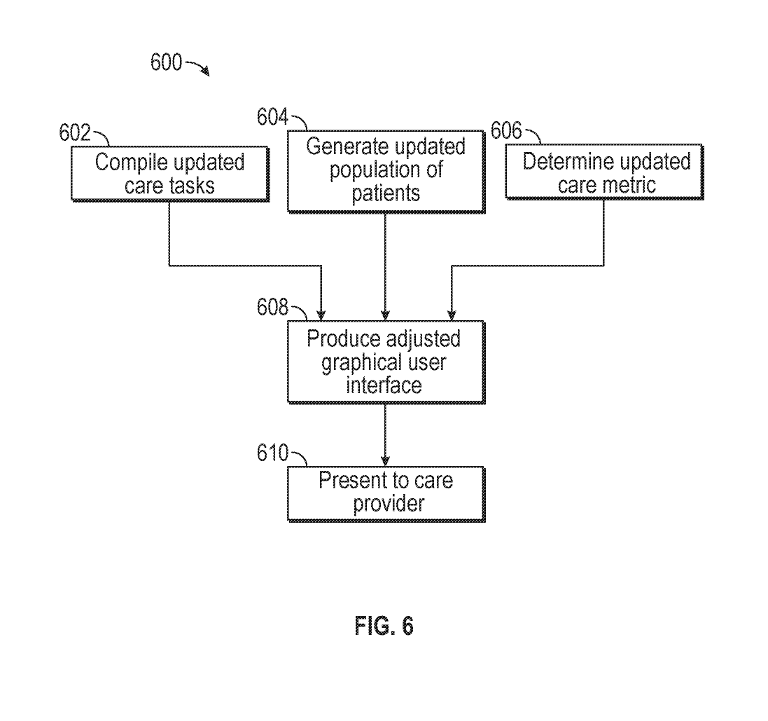

Because the graphical user interface produced in method 500 is reflective of a current state of patients, care tasks, and/or personalized care metrics, any or all of these elements may change after the interface is presented to a care provider in step 514. For example, patients may be discharged, urgent care requests may be received, and/or a particular personalized care metric of a care provider may improve, each of which may change the prioritization of a set of care tasks presented on the graphical user interface. To address this eventuality, embodiments of the invention may produce an adjusted graphical user interface based on updated information, as exemplified in method 600 illustrated in FIG. 6.

Method 600 begins at step 602, in which processor 106 generates an updated set of care tasks. As before in step 508, this updated list may be generated based on the identity established in step 506 and/or a population of patients generated in step 504. Some care tasks may be removed from the original set of care tasks due to completion or obviation of need, while others may be added.

Similarly, in step 604, an updated population of patients may be generated for a sensed location of care as in step 504. In some embodiments, this may be updated using the same location of care sensed in step 502, while in others a new location of care may be sensed, for instance if a doctor carries an electronic device operating an embodiment of the invention between departments 306 of a hospital 302.

In step 606, the care metric determined in step 510 for one or more providers of care based on an identity established in step 506 is updated based on newly documented and/or collected patient care and experience data. The care metric may be the same as that determined in step 510, or may be a distinct set of care metrics. In embodiments, only a value of one care metric may be updated in step 606.

As will be readily appreciated, steps 602, 604, and 606 may be performed simultaneously in embodiments of the invention or in any appropriate order. Specifically, step 602 may be completed after step 604 in embodiments because addition or removal of a patient from the population in step 604 will affect the set of care tasks to be completed compiled in step 602.

In step 608, an adjusted graphical user interface is produced based on the updated set of care tasks, population of patients, and care metrics. This may be the same type of graphical user interface produced in step 512, such as a prioritized task list or heat map, or may be of a completely different type. The adjusted graphical user interface is presented to one or more providers of care in step 610, as described above in step 514.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of presenting care tasks to a set of care providers, the method comprising the steps of:
generating a graphical user interface configured to display a set of care tasks for a population of patients at a location of care,
wherein the set of care tasks is compiled based on the location of care, and
wherein the graphical user interface is generated based, at least in part, on a personalized care metric of the set of care providers.

2. The method of claim 1, wherein the location of care is selected from a group consisting of a department, a floor, a room, a bed, and a clinic.

3. The method of claim 1, wherein each care provider in the set of care providers has a particular role.

4. The method of claim 1, wherein the personalized care metric of the set of care providers is restricted to care provided at the location of care.

5. The method of claim 1, wherein the personalized care metric of the set of care providers is restricted to care provided within a lookback period.

6. The method of claim 1, wherein the location of care is determined automatically via a location sensing component.

7. The system of claim 1, wherein the graphical user interface presents the set of care tasks with an expected time for completion.

8. The system of claim 1,
wherein the graphical user interface presents the set of care tasks with a particular care provider from the set of care providers associated with a particular care task in the set of care tasks,
wherein the particular care provider is responsible for completion of the particular care task.

9. A method of producing a graphical user interface presenting care tasks for a population of patients, the method comprising the steps of:
establishing an identity of a care provider,
sensing a location of care,
generating a population of patients for care at the location of care;
compiling a set of care tasks to be performed for the population of patients by the care provider;
determining a personalized care metric for the care provider; and
producing a graphical user interface presenting the set of care tasks based, at least in part, on the personalized care metric.

10. The method of claim 9, further including the steps of:
compiling an updated set of care tasks to be performed for the population of patients by the care provider; and
producing an adjusted graphical user interface presenting the updated set of care tasks based, at least in part, on the personalized care metric.

11. The method of claim 9, further including the steps of:
determining an updated personalized care metric for the care provider; and
producing an adjusted graphical user interface presenting the set of care tasks based, at least in part, on the updated personalized care metric.

12. The method of claim 9, wherein the personalized care metric is selected from a group consisting of Patient Request Rate, Patient Interaction Wait Time, Critical Request Rate, and Interruption Rate.

13. The method of claim 9, wherein the graphical user interface presents the set of care tasks in a prioritized task list.

14. The method of claim 9, wherein the graphical user interface presents the set of care tasks on a heat map.

15. A system for producing a graphical user interface presenting care tasks for a population of patients, the system comprising:
a processor;
an identity input component;
a location sensing component; and
a non-transitory computer readable medium storing computer-executable instructions which, when executed by the processor, perform the steps of:
establishing an identity of a care provider via the identity input component, sensing a location of care via the location sensing component, generating a population of patients based on the location of care;
compiling a set of care tasks to be performed for the population of patients by the care provider;
determining a personalized care metric for the care provider; and
producing a graphical user interface presenting the set of care tasks based, at least in part, on the personalized care metric.

16. The method of claim 15, wherein the identity input component comprises a fingerprint scanner.

17. The system of claim 15, wherein the location sensing component senses the location of care via GPS.

18. The system of claim 15, wherein the location sensing component senses the location of care based on a wireless connection.

19. The system of claim 18, wherein the wireless connection is selected from a group consisting of an RFID connection, a Bluetooth™ connection, and a Wi-Fi connection.

20. The system of claim 15, wherein the location sensing component senses the location of care based on a scanned indicium.
